(19) United States
(12) Patent Application Publication
(10) Pub. No.: US 2020/0053967 A1
(43) Pub. Date: Feb. 20, 2020

(54) LED GROW LIGHT WITH UVB EMITTERS

(71) Applicant: Truly Green Solutions, Inc., Chatsworth, CA (US)

(72) Inventor: Blake Thomas Murphy, Chatsworth, CA (US)

(21) Appl. No.: 16/445,107

(22) Filed: Jun. 18, 2019

Related U.S. Application Data
(60) Provisional application No. 62/686,227, filed on Jun. 18, 2018.

(51) Int. Cl. A01G 9/24; F21S 8/04; H05B 37/02

(52) U.S. Cl. CPC A01G 9/249; F21S 8/04; F21Y 2115/10; H05B 37/0281; H05B 37/0272

(57) ABSTRACT

Light fixtures with flexible luminaire arrangements and ultraviolet emitters designed to more closely mimic some of the desirable lighting characteristics of natural sunlight. In some embodiment, LEDs emitting in the UVB spectrum are mounted in the luminaire along with LED based luminaires emitting in other emission spectrum. The light from the UVB and other luminaires illuminate plants below to enhance growth characteristics. The UVB luminaires can be mounted in different locations and their emission can be controllable to match the desired plant growth conditions.

This application claims the benefit of U.S. Provisional Patent Application Ser. No. 62/686,227, filed on Jun. 18, 2018.

### BACKGROUND

### Field

The present invention relates generally to lighting devices, and more particularly to LED based lighting devices used to illuminate plants in indoor growing facilities, such as greenhouses.

### Description of the Related Art

In nature, plant growth relies on natural sunlight. Natural sunlight has three main characteristics, namely scattered emission, high intensity and a full spectrum. In greenhouse and indoor horticulture applications, growers use artificial lights that often try to mimic natural sunlight characteristics.

These indoor greenhouse lighting fixtures can be mounted from the greenhouse ceiling in a matter that allows light from the fixtures to illuminate the plants below. Many conventional greenhouse lighting fixtures utilize high intensity discharge (HID), high-pressure sodium (HPS), or fluorescent light sources.

More recently, with the advent of the efficient solid-state lighting sources, greenhouse light fixtures have been provided with LEDs. LEDs are solid state devices that convert electric energy to light and generally comprise one or more active regions of semiconductor material interposed between oppositely doped semiconductor layers. When a bias is applied across the doped layers, holes and electrons are injected into the active region where they recombine to generate light. Light is produced in the active region and emitted from surfaces of the LED.

LEDs have certain characteristics that make them desirable for many lighting applications that were previously the realm of incandescent, HID, HPS, or fluorescent light sources. Incandescent lights are very energy-inefficient light sources with approximately ninety percent of the electricity they consume being released as heat rather than light. Fluorescent light bulbs are more energy efficient than incandescent light bulbs by a factor of about 10, but are still relatively inefficient. LEDs by contrast, can emit the same luminous flux as incandescent and fluorescent lights using a fraction of the energy.

In addition, LEDs can have a significantly longer operational lifetime. Incandescent light bulbs have relatively short lifetimes, with some having a lifetime in the range of about 750-1000 hours. Fluorescent bulbs can also have lifetimes longer than incandescent bulbs, such as in the range of approximately 10,000-20,000 hours, but provide less desirable color reproduction. In comparison, LEDs can have lifetimes between 50,000 and 70,000 hours. The increased efficiency and extended lifetime of LEDs is attractive to many lighting suppliers and has resulted in their LED lights being used in place of conventional lighting in many different applications. It is predicted that further improvements will result in their general acceptance in more and more lighting applications.

Some indoor plant growers have adopted LED lights as the primary light source in indoor horticulture and greenhouses. However, LEDs are a different type of light source compared to conventional sources, and LEDS can have some performance drawbacks. One drawback is that LEDs typically emit in narrow emission spectrum and can often not be as effective as sunlight in enhancing plant growth.

### SUMMARY

The present disclosure relates to novel and improved light fixtures with flexible luminaire arrangements and ultraviolet emitters designed to more closely mimic sunlight. In some embodiment, LEDs emitting in the UVB spectrum are mounted in the luminaire with LED emitting in other emission spectrum. The light from the UVB emitters and the luminaires illuminate plants below to enhance growth characteristics. The UVB luminaires can be mounted in different locations and their emission can be controllable to match the desired plant growth.

One embodiment of a greenhouse light fixture according to the present invention comprises an elongated body having a mounting mechanism for mounting above a growing area. A plurality of primary emission luminaires is mounted to the body to illuminate the growing area. One or more secondary ultraviolet B (UVB) emitters are mounted to the body to also illuminate the growing area. The emission of the primary luminaires and secondary emitters is controllable to provide the desired light fixture emission to the growing area.

One embodiment of a greenhouse according to the present invention comprises a growing section arranged for growing plants. A plurality of light fixtures is mounted within the growing sections to illuminate the plants. Each of the light fixtures comprises a plurality of primary emission luminaires, and one or more secondary ultraviolet B (UVB) emitters. The emission of the primary luminaire and secondary emitters is controllable to provide the desired light fixture emission to said growing area.

These and other further features and advantages provided in this disclosure would be apparent to those skilled in the art from the following detailed description, taken together with the accompanying drawings.

### BRIEF DESCRIPTION OF THE DRAWINGS

FIG. 1 is a top perspective view of one embodiment of a light fixture according to the present invention;

FIG. 2 is a bottom perspective view of a light fixture according to the present invention;

FIG. 3 is a side view of one embodiment of a light fixture according to the present invention;

FIG. 4 is a partially exploded side view of a light fixture according to the present invention;

FIG. 5 is a bottom view of a light fixture according to the present invention;

FIG. 6 is another bottom view of a light fixture according to the present invention;

FIG. 7 is an end view of a light fixture according to the present invention;

FIG. 8 is a perspective view of a light fixture body according to the present invention;

FIG. 9 is a bottom view of a light fixture according to the present invention;

FIG. 10 is a side view of a light fixture according to the present invention; and

FIG. 11 is a table showing characteristics of one embodiment of a light fixture according to the present invention.

### DETAILED DESCRIPTION

Devices described herein can comprise novel and improved designs and layouts for lighting devices and fixtures that are particularly adapted for use as grow lights in greenhouses or as a grow light for other growing applications, such as for home growers. The different lamp embodiments according to the present invention can utilize ultraviolet (UV) radiation as part of the emission spectrum to enhance plant growth. UV radiation is made up of three types of rays; ultraviolet A (UVA), ultraviolet B (UVB), and ultraviolet C (UVC). The different embodiments can use emission from all three of these spectrums. Still other embodiments can utilize emission in the UVB spectrum, with light typically having wavelengths ranging from 280-315 nanometers. This spectrum is also commonly called the biological spectrum due to the human body's sensitivity to light of such a wavelength.

Throughout this disclosure, the preferred embodiment and examples illustrated should be considered as exemplars, rather than as limitations on the present disclosure. As used herein, the term “invention,” “device,” “apparatus,” “method,” “disclosure,” “present invention,” “present device,” present apparatus,” “present method,” or “present disclosure” refers to any one of the embodiments of the disclosure described herein, and any equivalents. Furthermore, reference to various feature(s) of the “invention,” “device,” “apparatus,” “method,” “disclosure,” “present invention,” “present device,” “present apparatus,” “present method,” or “present disclosure” throughout this document does not mean that all claimed embodiments or methods must include the referenced feature(s).

It is also understood that when an element or feature is referred to as being “on” or “adjacent” to another element or feature, it can be directly on or adjacent to the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or systems in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure. As used herein, the term “and/or” includes any and all combinations of one or more of the associated list items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It is further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Embodiments as described in the present disclosure can be described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure.

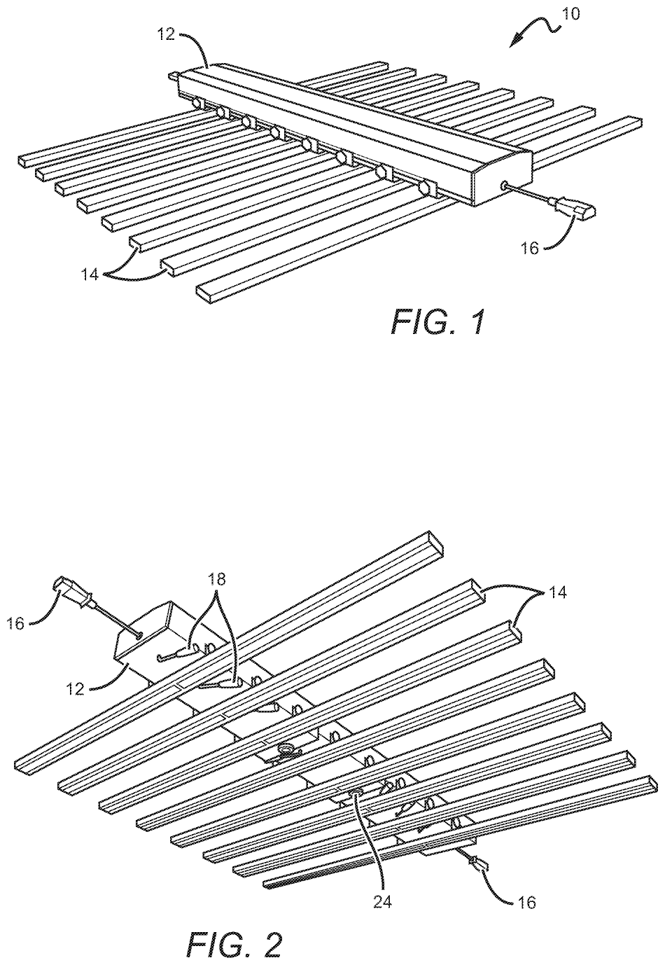

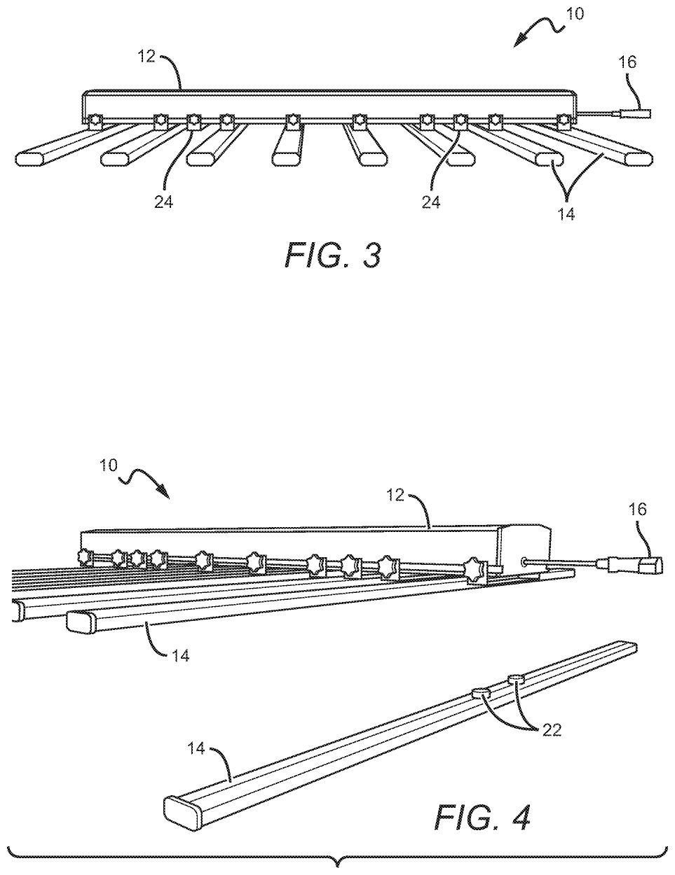

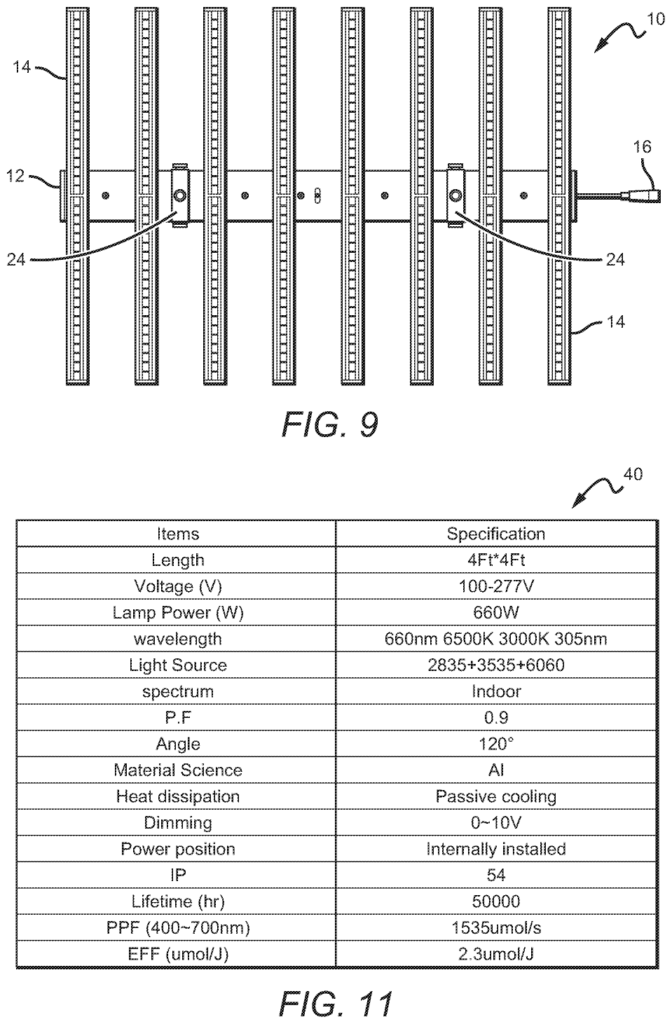

FIGS. 1-10 show one embodiment of an LED light fixture 10 according to the present invention comprising a body 12 running the length of the fixture 10, with elongated primary emission luminaires 14 mounted to the body 12. The primary emission luminaires can use many different light sources, with some embodiments utilizing one or more solid state light emitters, such as LEDs, as their light source. The luminaires 14 can be mounted orthogonal to the body 12, or can be mounted at different angles to the body 12. In some embodiments, the luminaires 14 in a particular fixture can be mounted at the same angle to the body 12, while in other embodiments the luminaires 14 in a particular fixture can be mounted at different angles to the body 12. The body 12 and luminaires 14 are shown and being elongated, but it is understood that both can have many different shapes and sizes beyond those shown and described herein.

The body 12 can comprise many different elements and features, with the body 12 comprising an internal power supply to drive the luminaires. The power supply can provide different power levels with some embodiments comprising adjustable power. In some embodiments the power supply can comprise less than 100 W, with some embodiments providing 80 W. The body can also have first connectors 16 at each end, with one end capable of connecting to external power and the other for connecting to another similar light fixture. The fixtures are then connected in series, with power from one conducting to the next through the connectors.

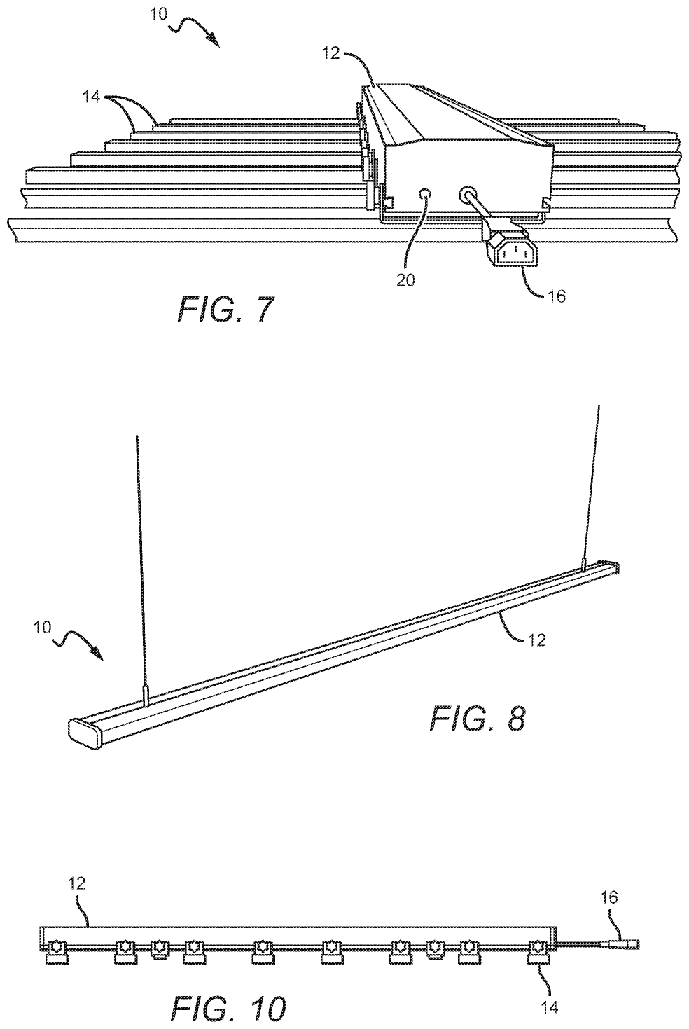

As best shown in FIG. 7, the body can also comprise a manual dimmer 20 that allows for manual operation for controlling emission intensity of the luminaires from zero to maximum (e.g. 0-10V). In other embodiments dimming can be controlled by other means, such as by wireless control. The body 12 can also be waterproof, with some embodiments having a waterproof level of International Protection rating of 54 (IP54).

Referring now to FIG. 2, the body 12 also comprises luminaire plug connectors 18 that each allow for power connection from the power supply in the body 12, to a respective one of the luminaires 14. This allows for an LED drive signal to be conducted from the body 12 to each of the luminaires 14. In some embodiments, each of the luminaires 14 is provided with the substantially same drive power, while in other embodiments the luminaires can be provided with different drive power. In some embodiments, the power supply can provide 80 W total to drive 8 luminaires 14. By providing substantially the same power to each luminaire, the irradiation area is substantially uniform and the PPFD values at the plants are substantially the same.

Referring now to FIG. 4, each of the luminaires 14 can comprise mounting magnets 22 that allow for convenient mounting of the luminaires 14 to the body 12. Different numbers of luminaires can be mounted to the body 12 and the luminaires 14 can be mounted in different locations on the body 12 and at different angles to the body 12. In some embodiments, the luminaires 14 are mounted equidistance apart along the length of the body 12, with the luminaires 14 orthogonal to the body 12. In some embodiments, the luminaires 14 can be arranged to tilt or rotate about the body 12 to give more control in the areas illuminated by the luminaires 14.

Each of the luminaires 14 can comprise a plurality of solid state light emitters along its length that are arranged to illuminate plants below the light fixture 10. The luminaires 14 can comprise LEDs emitting at substantially the same wavelength (or color) of light or can comprise LEDs that emit at different wavelengths of light. The LEDs in the luminaires can be controlled such that its luminaire emits different intensities of one wavelength range of light, or the LEDs can be individually controllable such that light from the LEDs can emit different intensities or different color combinations of LED light. For example, some luminaires can comprise red, green and blue emitting LEDs that can be controllable so that the luminaire emits a desired color of light that is a combination of light from the emitters.

The light fixture 10 can also comprise one or more secondary ultraviolet (UV) emitters that can be arranged in different locations to illuminate the plants below the fixture 10. In some embodiments the UV emitters can be integral to the body 12, integral to one of the luminaires 14, or provided in a separate UVB luminaire attached to the body 12 as described below. In some embodiments, the UV emitters can emit in the UVB range (280 to 315 nm), with some emitting at approximately UVB in the range of 300 to 310 nm. In still other embodiments, the UVB emitter can emit light with a wavelength of approximately 305 nm. Emissions of this wavelength can mimic a portion of the sun's UV radiation and can enhance some characteristics of plant growth. For example, this light emission can enhance the secretion of cannabis and can enhance the taste of cannabis.

The UVB emitters can have different emission patterns, with some having an approximate 180-degree emission pattern. Other embodiments can have approximate 160-degree emission pattern, which other embodiments can have an approximate 140-degree emission. In still other embodiments, having an approximate 120-degree emission pattern. The emission intensity and overall emission spectrum of fixture 10 can be tailored to particular requirements.

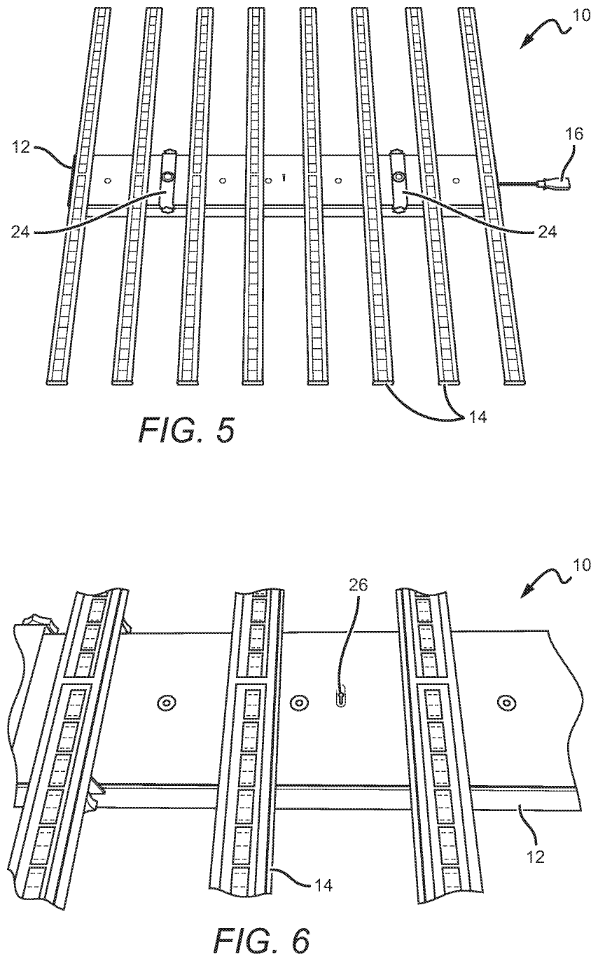

Referring now to FIG. 5, in some embodiments the UVB emitters can be provided in separate UVB luminaires 24 that can be mounted in different locations on the body 12. Different mounting mechanisms can be used according to the present invention, with some having a mounting mechanism that comprises magnets for mounting to the body 12. The UVB luminaires 24 can be mounted equidistance apart and orthogonal to the body 12 or can be at different distances apart and at different angles. The UVB luminaires 24 can also connect to the power supply within the body 12 by connectors as described above. In the embodiment shown, the UVB luminaires 24 comprise a single UVB LED, but in other embodiments they can comprise more than one. The UVB luminaires can be controllable to satisfy the growing requirement of the plants and as best shown in FIG. 6, can have a manual on/off switch 26 to turn off UVB emission when desired. Other embodiments having a wireless on/off control. Still other embodiments of the UVB luminaires 24 can have a manual or wireless dimming control. Different UVB emitters can be used in the UVB luminaires 24, with some embodiments utilizing a 100 mw UVB LED.

The UVB emitters can have a lens to help disperse light in the desired emission pattern. UVB light typically does not efficiently pass through conventional polycarbonate lenses used in other applications. Sapphire crystal (Al2O3) can more efficiently pass light in the UVB range. Sapphire lenses are also mechanically strong, with good thermal and chemical resistance. Sapphire is also scratch resistant making it compatible for lens applications. Sapphire is also inert and resistant to attack from most processing environments, such as hydrofluoric acid. It is understood that lenses of different material can also be used. The UVB emitters can use different lens shapes including plano convex, biconvex and concave. The lenses can also include antireflective coatings to increase efficiency in UV applications.

In some embodiments that luminaires 14 and UVB luminaires 18 can be controlled to illuminate in unison or individually, with the control that can be hardwired or wireless. The control can be integral, remote based or Wifi based control. The control can also be wireless using any wireless based devices and communication such as by Ethernet, Bluetooth, Zigbe, paired with a hub, Alexa/Google Home, Wifi/Lifi, Iot and compatible with control systems used in the lighting and other industries.

The emission of the luminaire 14 and/or UVB luminaire 18 can be controlled so that the lighting fixture 10 emits the desired color and intensity of light and can be controlled to mimic certain natural lighting conditions and cycles. For example, in some embodiments the luminaire 14 and UVB luminaire 18 can be controlled to mimic the sunrise and sunset lighting cycles. The emission intensity of the luminaires can turn on slowly so as to mimic the natural conditions of sunrise, and can turn off slowly to mimic the natural conditions of sunset. This gradual on and off can help avoid “shocking” the plant with instantaneous light.

FIG. 11 is a table 30 listing some of the characteristics of one embodiment of an LED based light fixture according to the present invention. These are only some of the features and characteristics of the different embodiments and some embodiments can have a different number of these features.

Although the present disclosure has been described in detail with reference to certain configurations thereof, other versions are possible. Therefore, the spirit and scope of the disclosure should not be limited to the versions described above.

The foregoing is intended to cover all modifications and alternative constructions falling within the spirit and scope of the disclosure as expressed in the appended claims, wherein no portion of the disclosure is intended, expressly or implicitly, to be dedicated to the public domain if not set forth in the claims.

We claim:

1. A greenhouse light fixture, comprising:
an elongated body having a mounting mechanism for mounting above a growing area;
a plurality of primary emission luminaires mounted to said body to illuminate said growing area;
one or more secondary ultraviolet B (UVB) emitters mounted to said body to also illuminate said growing area, wherein the emission of said primary luminaires and secondary emitters is controllable to provide the desired light fixture emission to said growing area.

2. The fixture of claim 1, wherein said body comprises a power supply to provide power to said luminaires and emitters.

3. The fixture of claim 2, wherein said power supply provides substantially the same power signal to said luminaires.

4. The fixture of claim 1, wherein said UVB emitters emit light in the wavelength range of 280 to 315 nanometers.

5. The fixture of claim 1, wherein said UVB emitters emit light in the wavelength range of 300 to 310 nanometers.

6. The fixture of claim 1, wherein said UVB emitters emit light with a wavelength of approximately 305 nanometers.

7. The fixture of claim 1, wherein said luminaires and said emitters utilize solid state light sources.

8. The fixture of claim 1, wherein said luminaires and said emitters comprise a dimmer control.

9. The fixture of claim 8, wherein said dimmer control is wirelessly operable.

10. The fixture of claim 9, wherein said luminaires are controllable to mimic the sunrise and sunset.

11. A greenhouse, comprising:
a growing section arranged for growing plants;
a plurality of light fixtures mounted within said growing sections to illuminate said plants, wherein each of said light fixtures comprises;
a plurality of primary emission luminaires;
one or more secondary ultraviolet B (UVB) emitters, wherein the emission of said primary luminaire and secondary emitters is controllable to provide the desired light fixture emission to said growing area.

12. The greenhouse of claim 11, wherein each of said light fixtures comprises a body with a power supply.

13. The greenhouse of claim 11, wherein each of said luminaires and each of said emitters are mounted to said body, said power supply providing power to said luminaires and emitters.

14. The greenhouse of claim 13, wherein said power supply provides substantially the same power signal to said luminaires.

15. The greenhouse of claim 11, wherein said UVB emitters emit light in the wavelength range of 280 to 315 nanometers.

16. The greenhouse of claim 11, wherein said UVB emitters emit light in the wavelength range of 300 to 310 nanometers.

17. The greenhouse of claim 11, wherein said UVB emitters emit light with a wavelength of approximately 305 nanometers.

18. The greenhouse of claim 11, wherein said luminaires and said emitters utilize solid state light sources.

19. The greenhouse of claim 11, wherein said luminaires and said emitters comprise a dimmer control.

20. A light fixture, comprising:
an elongated body having an internal power supply;
a mounting mechanism for mounting said body to ceiling;
a plurality of primary emission luminaires mounted to said body to illuminate the area below said fixture;
one or more secondary ultraviolet B (UVB) emitters mounted to said body to also illuminate said growing area, wherein said power supply provides a respective one of a plurality of power signals to each of said luminaires and emitters, and wherein each of said power signals controls the emission of its respective one of said primary luminaires and secondary emitters is to provide the desired light fixture emission.
